(19) United States
(12) Patent Application Publication
(10) Pub. No.: US 2016/0097930 A1
(43) Pub. Date: Apr. 7, 2016

(54) MICRODISPLAY OPTICAL SYSTEM HAVING TWO MICROLENS ARRAYS

(71) Applicants: Steven John Robbins, Redmond, WA (US); Yarn Chee Poon, Redmond, WA (US)

(72) Inventors: Steven John Robbins, Redmond, WA (US); Yarn Chee Poon, Redmond, WA (US)

(21) Appl. No.: 14/507,473

(22) Filed: Oct. 6, 2014

(51) Int. Cl. G02B 27/01; G02F 1/1335; G02B 5/18; G02B 27/28; G02B 3/00; G02B 5/30

(52) U.S. Cl. CPC G02B 27/0172; G02B 3/005; G02B 5/3041; G02B 5/1814; G02B 27/285; G02B 5/3083; G02F 1/133611; G02F 1/133606; G02F 1/13362; G02B 2027/0178; G02F 2001/133607

(57) ABSTRACT

The technology provides an optical system for converting a source of projected light to uniform light for a liquid crystal on silicon microdisplay in a confined space, such as in a near-eye display device. The optical system may include a first microlens array, a second microlens array, and a polarizer device disposed between the first microlens array and the second microlens array. The near-eye display device having first and second microlens arrays may be positioned by a support structure in a head-mounted display or head-up display.

### BACKGROUND

A near-eye display device (NED Device) may be worn by a user for experiences such as an augmented reality experience and a virtual reality experience. A NED Device may include a projection light engine that may provide a computer-generated image, or other information, in a near-eye display of the NED Device. In an augmented reality experience, a near-eye display of a NED Device may include optical see-through lens to allow a computer-generated image to be superimposed on a real-world view of a user.

A NED Device may be included in a head-mounted display or head-up display. A head-mounted display may include a NED Device in a helmet, visor, glasses, and goggles or attached by one or more straps. Head-mounted displays may be used in at least aviation, engineering, science, medicine, computer gaming, video, sports, training, simulations and other applications. Head-up displays may be used in at least military and commercial aviation, automobiles, computer gaming, and other applications.

### SUMMARY

The technology provides an optical system for converting a source of projected light to uniform light for a liquid crystal on silicon microdisplay in a confined space. In an embodiment, the optical system includes a first microlens array, a second microlens array, and a polarizer device disposed between the first microlens array and the second microlens array.

The technology also provides a method for converting a source of projected light to uniform light for a liquid crystal on silicon microdisplay in a confined space. In an embodiment the method includes directing the projected light to a first microlens array, polarizing light from the first microlens array, directing the polarized light to a second microlens array to generate uniform light, and directing the uniform light from the second microlens array to the liquid crystal on silicon microdisplay.

The technology also provides an apparatus including a computer system that provides an electronic signal representing image data, and a head-mounted display that provides image data in response to the electronic signal. The head-mounted display includes a near-eye display device including a projection light engine. The projection light engine has a microdisplay to provide the image data in response to the electronic signal, a light source to provide projected light, a first microlens array to receive the projected light from the light source, a polarizer device to generate polarized light from the first microlens array and a second microlens array to receive the polarized light from the polarizer and to provide uniform light to the microdisplay.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram depicting example components of an embodiment of an NED Device system.

FIG. 2A is a block diagram of example hardware components in control circuitry of a NED device.

FIG. 2B is a top view of an embodiment of a near-eye display coupled to a projection light engine.

FIG. 3A is a block diagram of an embodiment of a projection light engine that includes an image optical system that includes a first and second microlens array and a microdisplay.

FIG. 3B is a block diagram illustrating a top view of layers of a waveguide example illustrated in FIG. 3A.

FIGS. 4A-4B are block diagrams of an embodiment of an image optical system that includes a first and second microlens array and a microdisplay.

FIGS. 4C-4D are block diagrams of another embodiment of an image optical system that includes a first and second microlens array and a microdisplay.

FIG. 5 illustrates an embodiment of a housing a projection light engine for a near-eye display in a NED Device using an eyeglass frame.

FIG. 6 is a block diagram of an embodiment of a system from a software perspective for displaying image data by a NED Device.

FIG. 7 is a flowchart of an embodiment of a method for operating a NED Device and/or NED Device system.

FIG. 8 is a block diagram of one embodiment of a computer system that can be used to implement a network accessible computing system, a companion processing module or control circuitry of a NED Device.

### DETAILED DESCRIPTION

The technology provides embodiments of optical systems and methods for converting a source of projected light to generate a uniform image for a microdisplay in confined space in an NED Device using a first microlens array and a second microlens array.

A NED Device typically includes an optical system that includes a light source, such as one or more light emitting diodes (LEDs), that illuminates a microdisplay, such as a LCoS microdisplay. To provide an acceptable image on an LCoS microdisplay, the light source must provide a uniform illumination pattern. Thus, previously known optical systems typically include a microlens array (MLA) disposed between the light source and the LCoS microdisplay to provide a uniform illumination pattern for the LCoS microdisplay. In addition, because an LCoS microdisplay requires polarized light, but LEDs emit unpolarized light, previously known optical systems typically include a polarization convertor to convert unpolarized light from the LEDs to polarized light for the LCoS microdisplay.

An optical system for an NED Device, however, often must fit within a very constrained mechanical outline. Although a polarization converter may be made of various materials and thicknesses, there is a limit to how thin a polarization converter can be made. Because the polarization converter and MLA must both fit within a constrained mechanical outline, the limit on the dimensions of the polarization converter limit the maximum size of the MLA, which in turn limits the number of microlenses that may be included in the MLA. But a limit on the number of microlenses in the MLA means that the LCoS microdisplay may not be uniformly illuminated, and hence the image quality may be unacceptable.

This technology provides an optical system for converting a source of projected light to generate a uniform image for a microdisplay in confined space, such as in an NED device. In an embodiment, this technology provides an optical system that includes a first microlens array, a second microlens array, and a polarizer device between the first microlens array and the second microlens array. The first microlens array and polarizer device may be much smaller than previously known polarization converters, and thus the optical system may be implemented in a confined space, such as in an NED device. An NED Device having first and second microlens arrays and polarizer device may be included in a projection light engine disposed by a support structure of a head-mounted display or head-up display.

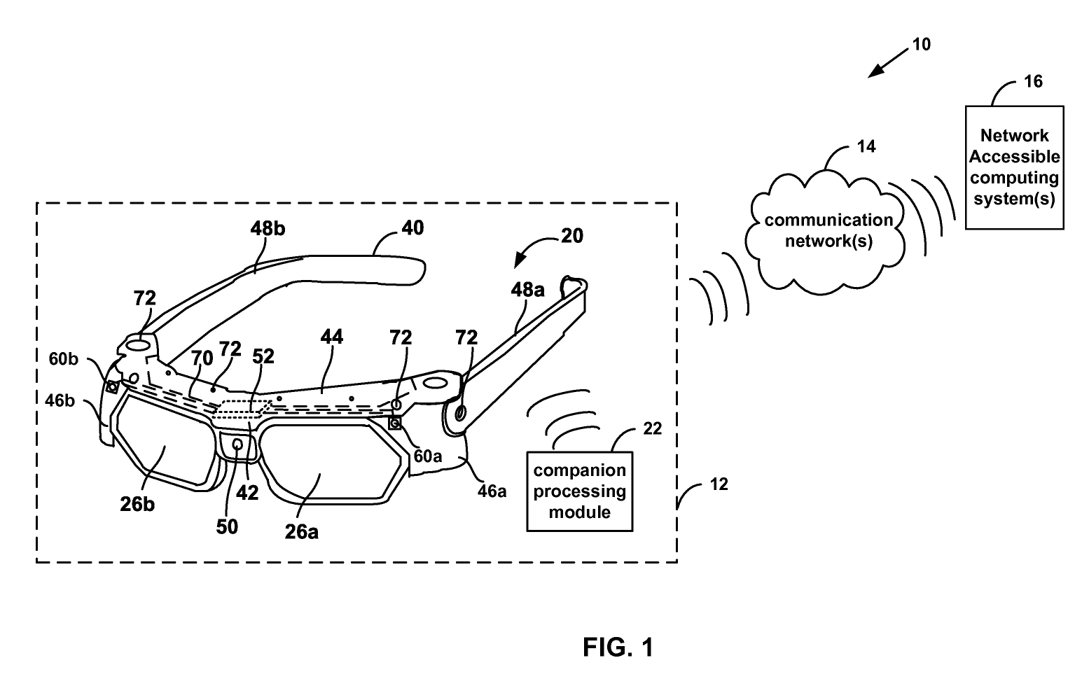

FIG. 1 is a block diagram of an embodiment of a NED system 10 that may include a NED Device 12, a communication(s) network 14 and a network accessible computing system(s) 16.

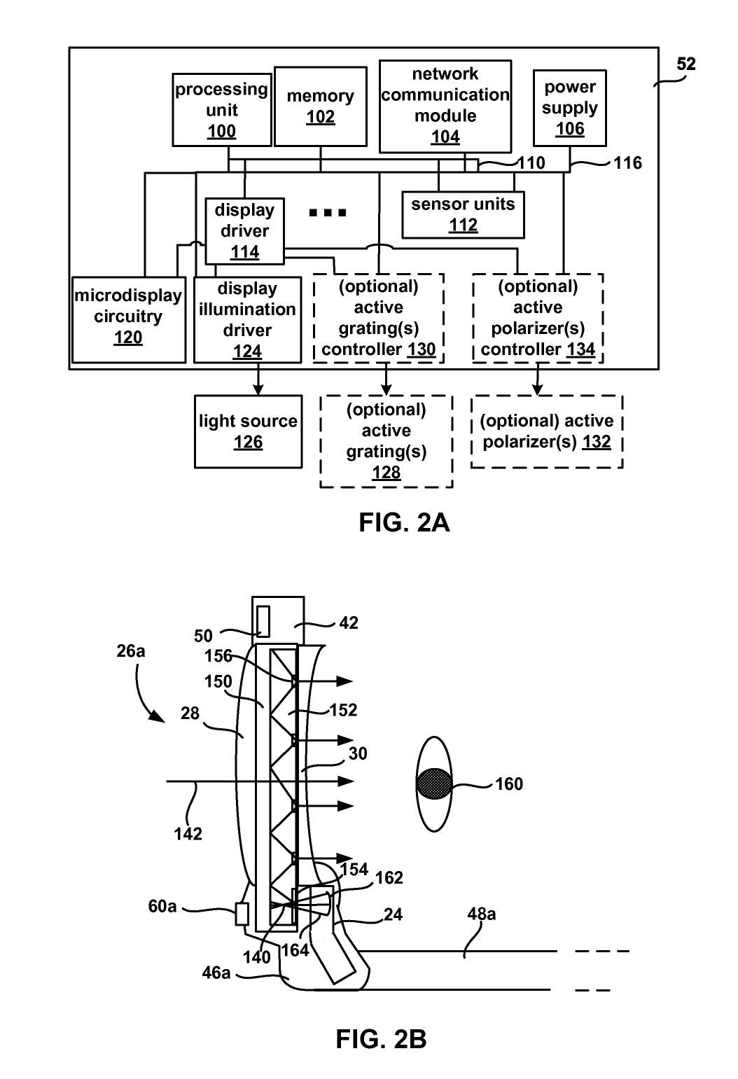

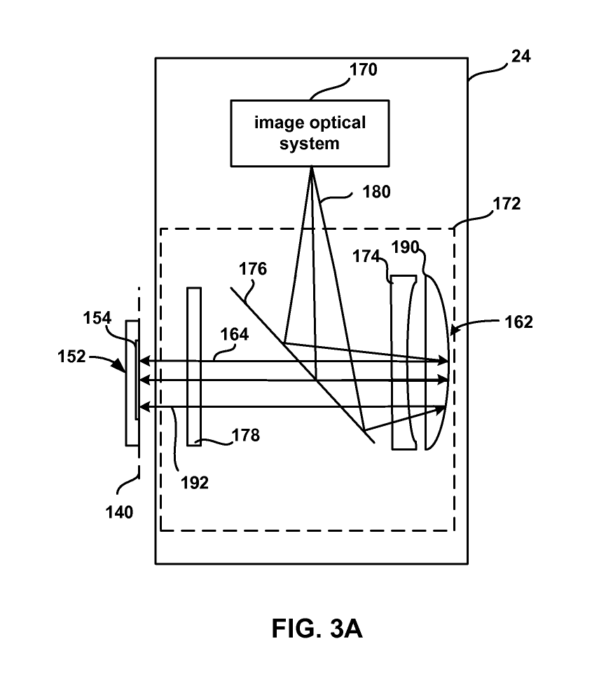

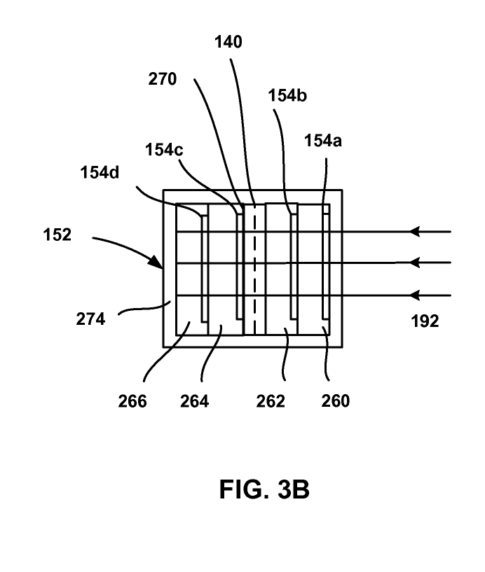

In an embodiment, NED Device 12 includes a head-mounted display 20 communicatively coupled to a companion processing module 22. Wireless communication is illustrated in this example, but communication via a wire between head-mounted display 20 and companion processing module 22 may also be implemented. In an embodiment, head-mounted display 20 includes a projection light engine 24 (shown in FIGS. 2B and 3) and a near-eye displays 26a and 26b having a waveguide as described in detail herein. In alternate embodiments, NED Device 12 may be implemented in a head-up display.

Referring again to FIG. 1, head-mounted display 20 is in the shape of eyeglasses having a frame 40, with each of near-eye displays 26a and 26b positioned at the front of the head-mounted display 20 to be seen through by each eye when worn by a user. In this embodiment, each of near-eye displays 26a and 26b uses a projection display in which image data (or image light) is projected into a user's eye to generate a display of the image data so that the image data appears to the user at a location in a three dimensional field of view in front of the user. For example, a user may be playing a shoot down enemy helicopter game in an optical see-through mode in his living room. An image of a helicopter appears to the user to be flying over a chair in his living room, not between optional lenses 28 and 30, shown in FIG. 2B, as a user cannot focus on image data that close to the human eye.

In this embodiment, frame 40 provides a convenient eyeglass frame holding elements of the head-mounted display 20 in place as well as a conduit for electrical connections. In an embodiment, frame 40 provides a NED Device support structure for projection light engine 24 and near-eye displays 26a and 26b as described herein. Some other examples of NED Device support structures are a helmet, visor frame, goggles, support or one or more straps.

In an embodiment, frame 40 includes a nose bridge 42, a front top cover section 44, a left side projection light engine housing 46a and a right side projection light engine housing 46b, and left side arm 48a and right side arm 48b, which are designed to rest on each of a user's ears. In this embodiment, nose bridge 42 includes a microphone 50 for recording sounds and transmitting audio data to control circuitry 52. On the exterior of left side projection light engine housing 46a and right side projection light engine housing 46b are respective outward facing cameras 60a and 60b, respectively, which capture image data of the real environment in front of the user for mapping what is in a field of view of NED Device 12.

In this embodiment, dashed lines 70 illustrate examples of electrical connection paths which connect to control circuitry 52, also illustrated in dashed lines. One dashed electrical connection line is labeled 70 to avoid overcrowding the drawing. The electrical connections and control circuitry 52 are in dashed lines to indicate they are under the front top cover section 44 in this example. There may also be other electrical connections (not shown) including extensions of a power bus in left side arm 48a and right side arm 48b for other components, some examples of which are sensor units including additional cameras, audio output devices like earphones or units, and perhaps an additional processor and memory. Connectors 72, such as screws or other connectors, may be used to connect the various parts of frame 40.

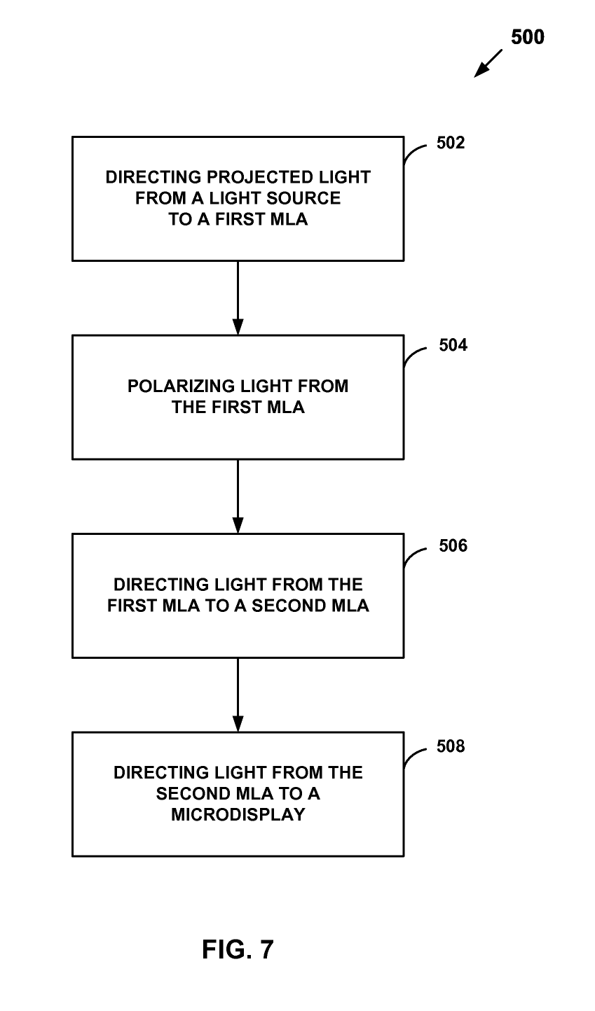

Companion processing module 22 may take various forms. In some embodiments, companion processing module 22 is in a portable form which may be worn on the user's body, e.g. a wrist, or be a separate portable computer system like a mobile device (e.g. smartphone, tablet, laptop). Companion processing module 22 may communicate using a wire or wirelessly (e.g., WiFi, Bluetooth, infrared, an infrared personal area network, RFID transmission, wireless Universal Serial Bus (WUSB), cellular, 3G, 4G or other wireless communication means) over one or more communication networks 14 to one or more network accessible computing system(s) 16, whether located nearby or at a remote location. In other embodiments, the functionality of companion processing module 22 may be integrated in software and hardware components of head-mounted display 20. Some examples of hardware components of companion processing module 22 and network accessible computing system(s) 16 are shown in FIG. 7, described below.

One or more network accessible computing system(s) 16 may be leveraged for processing power and remote data access. The complexity and number of components may vary considerably for different embodiments of the network accessible computing system(s) 16 and companion processing module 22. In an embodiment, network accessible computing system(s) 16 may be located remotely or in a Cloud operating environment.

Image data is identified for display based on an application (e.g., a game or messaging application) executing on one or more processors in control circuitry 52, companion processing module 22 and/or network accessible computing system(s) 16 (or a combination thereof) to provide image data to near-eye displays 26a and 26b.

FIG. 2A is a block diagram of example hardware components including a computer system within control circuitry 52 of NED Device 12. Control circuitry 52 provides various electronics that support other components of head-mounted display 20. In this example, control circuitry 52 includes a processing unit 100, a memory 102 accessible to processing unit 100 for storing processor readable instructions and data, a network communication module 104 communicatively coupled to processing unit 100 which can act as a network interface for connecting head-mounted display 20 to another computer system such as companion processing module 22, a computer system of another NED Device or one which is remotely accessible over the Internet. A power supply 106 provides power for the components of control circuitry 52 and other components of head-mounted display 20, like capture devices 60, microphone 50, other sensor units, and for power drawing components for displaying image data on near-eye displays 26a and 26b, such as light sources and electronic circuitry associated with an image source, like a microdisplay in a projection light engine.

Processing unit 100 may include one or more processors (or cores) such as a central processing unit (CPU) or core and a graphics processing unit (GPU) or core. In embodiments without a separate companion processing module 22, processing unit 100 may contain at least one GPU. Memory 102 is representative of various types of memory which may be used by the system, such as random access memory (RAM) for application use during execution, buffers for sensor data including captured image data and display data, read only memory (ROM) or Flash memory for instructions and system data, and other types of nonvolatile memory for storing applications and user profile data, for example. FIG. 2A illustrates an electrical connection of a data bus 110 that connects sensor units 112, display driver 114, processing unit 100, memory 102, and network communication module 104. Data bus 110 also derives power from power supply 106 through a power bus 116 to which all the illustrated elements of control circuitry 52 are connected for drawing power.

Control circuitry 52 further includes a display driver 114 for selecting digital control data (e.g., control bits) to represent image data that may be decoded by microdisplay circuitry 120 and different active component drivers of a projection light engine. An example of an active component driver is a display illumination driver 124 which converts digital control data to analog signals for driving a light source 126, which may include one or more light sources, such as one or more lasers or light emitting diodes. In some embodiments, a display unit may include one or more active gratings 128, such as for a waveguide for coupling the image light at the exit pupil from the projection light engine. An optional active grating(s) controller 130 converts digital control data into signals for changing the properties of one or more optional active grating(s) 128. Similarly, one or more polarizers of a projection light engine may be active polarizer(s) 132 which may be driven by an optional active polarizer(s) controller 134. Control circuitry 52 may include other control units not illustrated here but related to other functions of a head-mounted display 20, such as providing audio output, identifying head orientation and location information.

FIG. 2B is a top view of an embodiment of a near-eye display 26a coupled with a projection light engine 24 having an external exit pupil 140. To show the components of near-eye display 26a for the left eye, a portion of top frame section 44 covering near-eye display 26a and projection light engine 24 is not depicted. Arrow 142 represents an optical axis of the near-eye display 26a.

In this embodiment, near-eye displays 26a and 26b are optical see-through displays. In other embodiments, they can be video-see displays. Each of near-eye displays 26a and 26b includes a display unit 150 that includes a waveguide 152. In an embodiment, display unit 150 is disposed between two optional see-through lenses 28 and 30, which are protective coverings for display unit 150. One or both of see-through lenses 28 and 30 may also be used to implement a user's eyeglass prescription. In this example, eye space 160 approximates a location of a user's eye when head-mounted display 20 is worn by the user.

Waveguide 152 directs image data in the form of image light from projection light engine 24 towards a user eye space 160, while also allowing light from the real world to pass through towards user eye space 160, thereby allowing a user to have an actual direct view of the space in front of head-mounted display 20, in addition to seeing an image of a virtual feature from projection light engine 24.

In this top view, projection light engine 24 includes a mirror 162 illustrated as a curved surface. The curved surface provides optical power to the beams 164 of image light (also described as image light 164) it reflects, thus collimating them as well. Only one beam is labeled to prevent overcrowding the drawing. Beams 164 are collimated but come from different angles as they reflect from different points of the curved surface. Thus, beams 164 will cross and form exit pupil 140 at the smallest cross-section of themselves.

In some embodiments, waveguide 152 may be a diffractive waveguide, a surface relief grating waveguide, or other waveguide. Waveguide 152 includes an input grating 154 that couples image light from projection light engine 24, and includes a number of exit gratings 156 for image light to exit waveguide 152 towards user eye space 160. One exit grating 156 is labeled to avoid overcrowding the drawing. In this example, an outermost input grating 154 is wide enough and positioned to capture light exiting projection light engine 24 before the light exiting projection light engine 24 has reached exit pupil 140. The optically coupled image light forms its exit pupil 140 in this example at a central portion of waveguide 152. FIGS. 3A-3B, described below, provide an example of waveguide 152 coupling the image light at exit pupil 140 with an input grating positioned at exit pupil 140.

Exit pupil 140 includes the light for the complete image being displayed, thus coupling light representing an image at exit pupil 140 captures the entire image at once, and is thus very efficient and provides the user a view of the complete image in near-eye displays 26a and 26b. Input grating 154 couples image light of exit pupil 140 because exit pupil 140 is external to projection light engine 24. In an embodiment, exit pupil 140 is 0.5 mm outside projection light engine 24 or a housing of projection light engine 24. In other embodiments, exit pupil 140 is projected 5 mm outside projection light engine 24 or a housing of projection light engine 24.

In the embodiment of FIG. 2B, projection light engine 24 in left side housing 46a includes an image source, for example a microdisplay which produces the image light, and a projection optical system which folds an optical path of the image light to form exit pupil 140 external to projection light engine 24. The shape of projection light engine 24 is an illustrative example adapting to the shape of left side housing 46a, which conforms around a corner of frame 40 to reduce bulkiness. The shape may be varied to accommodate different arrangements of projection light engine 24 due to different image source technologies implemented.

FIG. 2B shows half of head-mounted display 20. For the illustrated embodiment, a full head-mounted display 20 may include near-eye displays 26a and 26b with another set of optional see-through lenses 28 and 30, another waveguide 152, as well as another projection light engine 24, and another of outward facing capture devices 60. In some embodiments, there may be a continuous display viewed by both eyes, rather than a display optical system for each eye. In some embodiments, a single projection light engine 24 may be optically coupled to a continuous display viewed by both eyes, or may be optically coupled to separate displays for the eyes. Additional details of a head mounted personal A/V apparatus are illustrated in Flaks et al. U.S. Patent Publication No. 2012-0092328.

FIG. 3A is a block diagram of an embodiment of a projection light engine 24 that includes a first optical system 170 and a second optical system 172. In an embodiment, first optical system 170 generates image light 180, and is also referred to herein as image optical system 170. In an embodiment, second optical system 172 projects image light 180 to exit pupil 140, and is also referred to herein as projection optical system 172.

In an embodiment, projection optical system 172 includes mirror 162, an aspheric optical element 174, an optical directing element 176, and one or more polarizing optical elements 178 (referred to herein as “polarizer 178”). Image optical system 170 generates image light 180, which propagates into projection optical system 172, which folds the optical path to provide image light 192 at an exit pupil 140 external to projection light engine 24. This side view illustrates some exemplary basic elements associated with a projection optical system 172. Additional optical elements may be present.

In an embodiment, mirror 162 is a spherical reflective mirror having a curved reflective surface 190, and aspheric optical element 174 is a Schmidt corrector lens, or at least one aspheric lens disposed along an optical path between optical directing element 176 and mirror 162. Aspheric optical element 174 is used to correct optical aberrations in image light reflected from curved reflective surface 190.

Optical directing element 176 directs image light 180 from image optical system 170 to curved reflective surface 190 of mirror 162 and allows image light reflecting from curved reflective surface 190 to pass through polarizer 178 to form image light 192. An example of optical directing element 176 is a beam splitter, which also may act as a polarizer, so that mirror 162 receives polarized light, which is again polarized by polarizer 178. In some embodiments, optical directing element 176 may be a cube beam splitter, plate beam splitter, wire-grid polarizer beam splitter or internally refractive beam splitter. In some embodiments, polarizer 178 may include passive optical elements like a red rotation waveplate or a quarter waveplate. Active polarizers may be used in some embodiments as described herein.

Image light 192 is polarized for more efficient coupling into one or more input gratings 154 of waveguide 152. In some examples, waveguide 152 may have multiple layers, and the polarization of image light 192 can be used for filtering the incoming light to different layers of waveguide 152. Each layer has its own input grating and exit grating. An input grating for a layer couples light of a certain polarization into its layer. Light of other polarizations passes through the input grating and the layer itself so that an input grating of the next layer either couples or passes the received light based on its polarization. In some implementations, different wavelength bands, such as for different colors, may be directed to different waveguide layers for enhancing brightness of the image. Light in the different wavelength bands may be polarized for coupling into a respective layer for each wavelength band. See, e.g., Nguyen et al. U.S. Patent Publication No. 2014-0064655.

The arrangement of one or more polarizing optical elements within projection optical system 172 may be based on a number of factors, including a number of layers in waveguide 152, the types of gratings (e.g., surface relief gratings), and a predetermined criteria for distributing the image light among the layers. Beams 164 are collimated when reflected from curved reflective surface 190 of mirror 162, but each portion is reflecting from a different angle due to the curved surface. In this embodiment, input grating 154 of waveguide 152 couples the reflected beam at about a location of exit pupil 140. In this embodiment, waveguide 152 may be a single layer waveguide. In other embodiments, a multi-layer waveguide may be implemented in near-eye displays 26a and 26b.

A cross-sectional side view of waveguide 152 is shown in FIG. 3B. Waveguide 152 extends into the page and into near-eye display 26a approximately parallel to eye area 160 and extends a much smaller amount out of the page. In this embodiment, waveguide 152 is multi-layered with four exemplary layers, 260, 262, 264 and 266, and a center waveplate 270. Persons of ordinary skill in the art will understand that waveguide 152 may include more or fewer than four layers. Center waveplate 270 includes a target location for exit pupil 140 to be projected.

In this embodiment, an outer protective covering 274 of see-through glass surrounds waveguide 152 through which image light 192 passes. Waveguide 152 is positioned within housing 46 for optical coupling of the image light of exit pupil 140 in center waveplate 270. In an embodiment, each of layers 260, 262, 264 and 266 has its own input grating 154. An example of an input grating 154 is a surface relief grating manufactured as part of the surface of each layer in waveguide 152.

Layer 260 first receives image light 192 which has exited projection light engine 24, and couples that light through its optical input grating 154a. Similarly, layer 262 couples image light 192 through its optical input grating 154b. Center waveplate 270 couples and changes the polarization state of image light 192 it has received including exit pupil 140. Layer 264 via optical input grating 154c couples image light 192 as its cross section expands, and layer 266 couples image light 192 with its optical grating 154d as the cross section of image light 192 continues to expand.

As illustrated in FIG. 2B, in some embodiments, projection light engine 24 has a shape that adapts to the shape of left side housing 46a, which conforms around a corner of frame 40. In addition, as illustrated in FIG. 3A, projection light engine 24 includes image optical system 170 and projection optical system 172. As a result, projection light engine 24 often must fit within a constrained mechanical outline, which in turn means that image optical system 170 also must fit within a very constrained mechanical outline. For example, image optical system 170 may be required to fit within a mechanical outline having dimensions of less than about 24 mm×21 mm×9 mm. Other mechanical outline dimensions may be required.

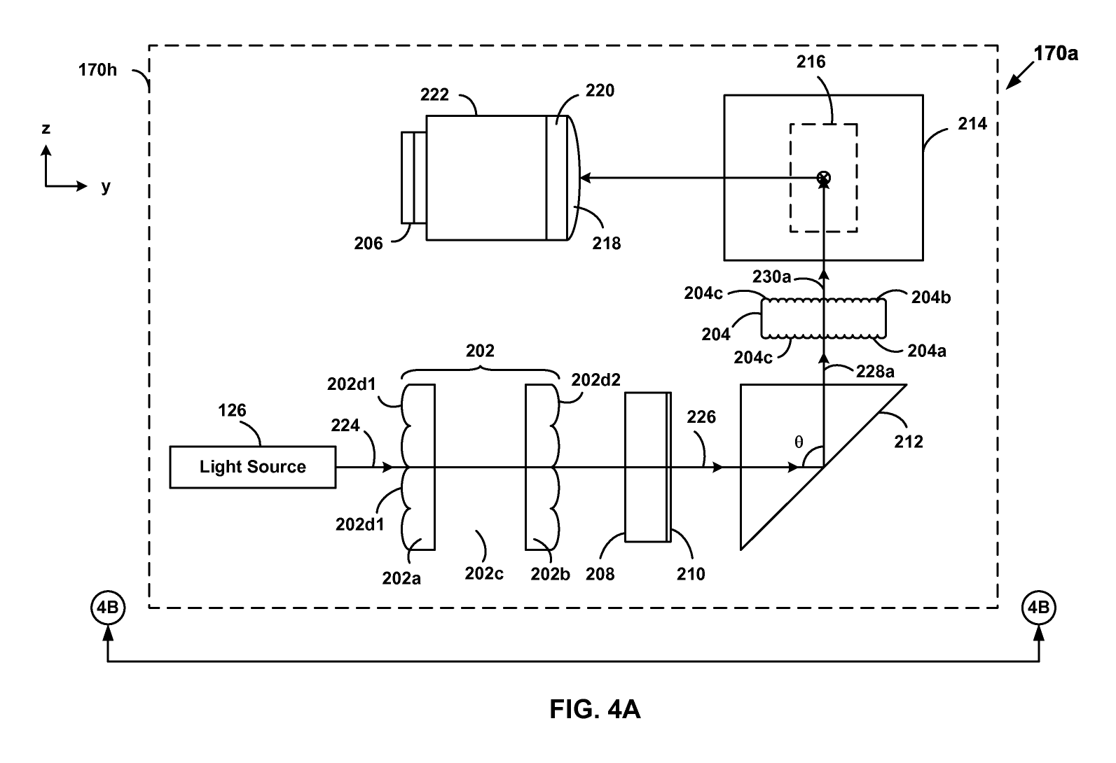

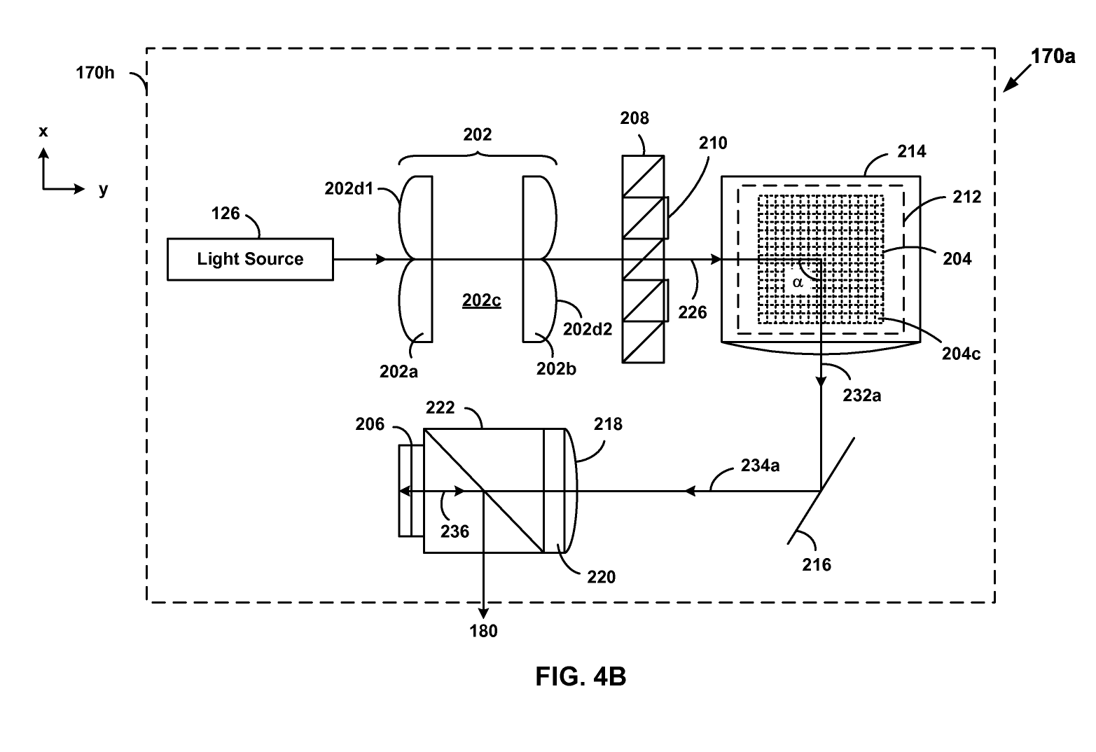

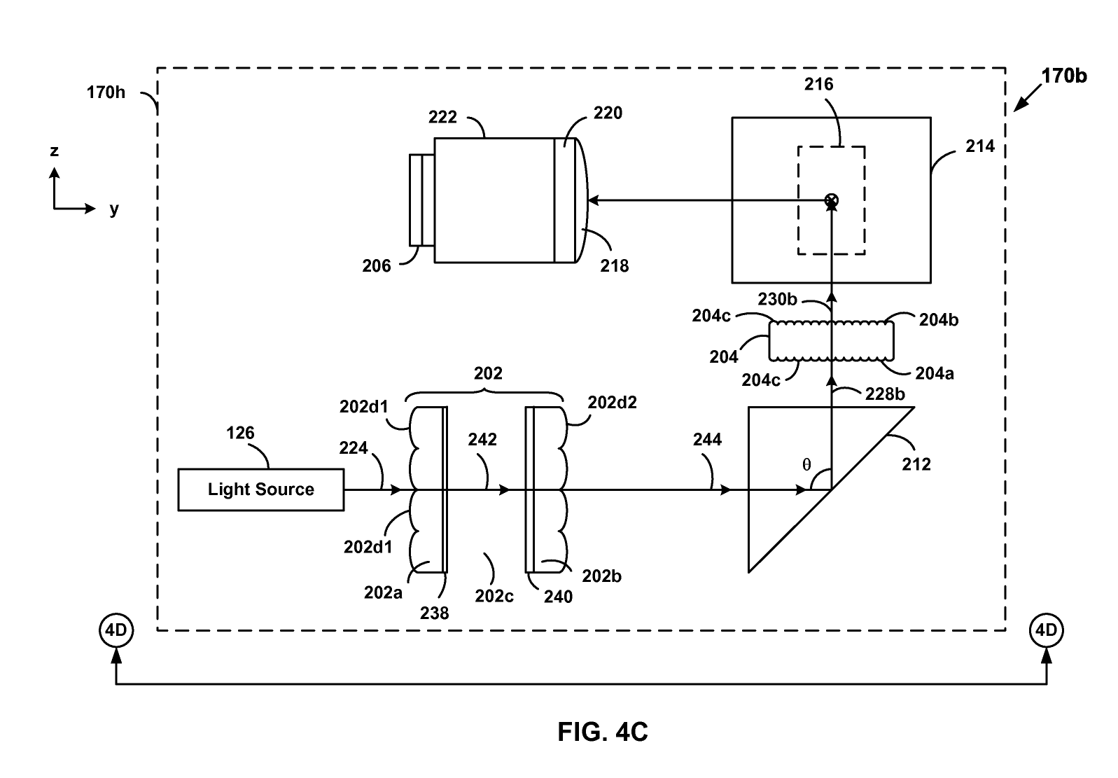

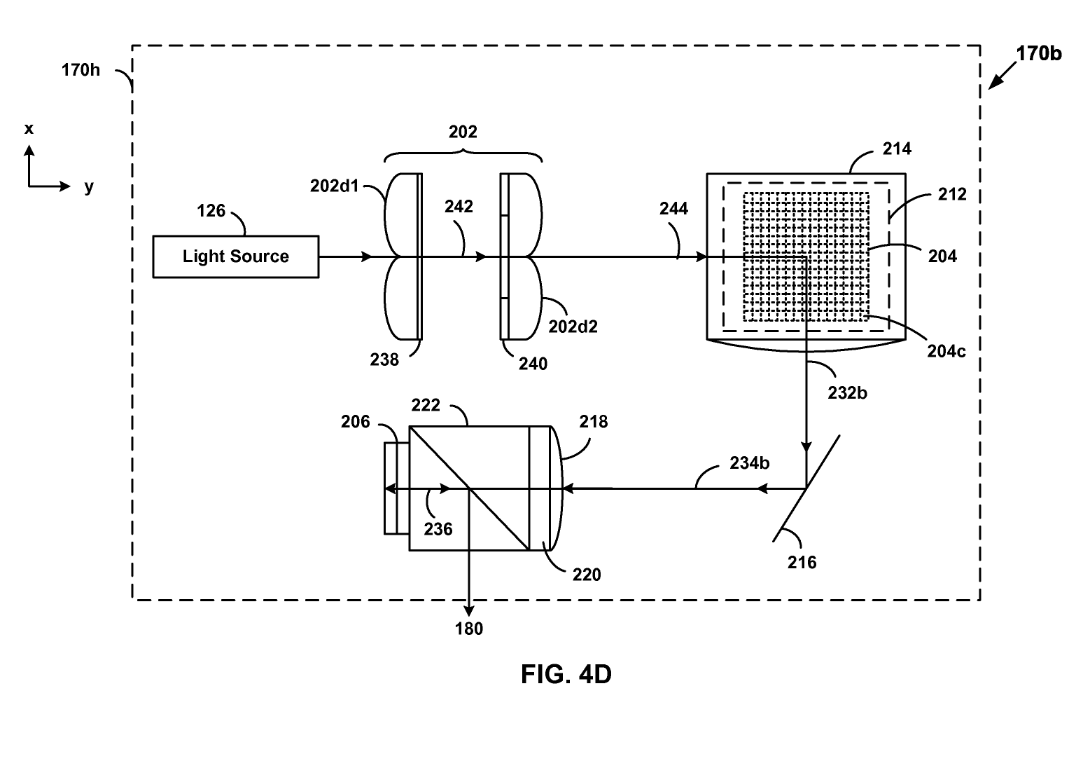

Referring now to FIGS. 4A-4B, an embodiment of image optical system 170 is described that may be used to fit within an optical system housing 170h having a constrained mechanical outline, such as may be required in NED Device 12. In particular, image optical system 170a includes a light source 126, a first microlens array 202, a second microlens array 204 and a microdisplay 206. In some embodiments, image optical system 170a may include additional optical components, such as a polarization converter array 208, a half-wave retarder 210, a fold prism 212, a fold prism with relay lens 214, a mirror 216, a relay lens 218, a polarizer 220, and a beamsplitter 222.

Light source 126 may include one or more lasers or light emitting diodes. First microlens array 202 focuses projected light 224 from light source 126 into polarization converter array 208 (e.g., a MacNeille beam splitter) and half-wave retarder 210, which convert unpolarized projected light 224 to polarized light 226. Fold prism 212 folds polarized light 226 an angle θ (e.g., θ=90°), and redirects the folded image light 228a to second microlens array 204, which has a first surface 204a and a second surface 204b.

Second microlens array 204 collects the folded light 228a from fold prism 212, and redirects the collected light to second surface 204b. Fold prism with relay lens 214 folds image light 230a from second microlens array 204 an angle α (e.g., α=90°), and magnifies the folded light to form magnified image light 232a. Mirror 216 reflects magnified image light 232a to direct reflected light 234a towards relay lens 218, which converges reflected light 234a (via polarizer 220 and beamsplitter 222) to microdisplay 206. Microdisplay 206 reflects imaged light 236, which is folded by beamsplitter 222 and output as image light 180.

Microdisplay 206 may be a liquid crystal on silicon (LCoS) device. In other embodiments, microdisplay 206 may be implemented using a transmissive projection technology, or an emissive or self-emissive technology where light is generated by the display. An example of an emissive or self-emissive technology is organic light emitting diode technology.

First microlens array 202 includes a first microlens array portion 202a and second microlens array portion 202b, with a gap 202c disposed between first microlens array portion 202a and second microlens array portion 202b. First microlens array portion 202a includes a number of first microlenses 202d1 that are arranged with their convex surfaces facing outward away from gap 202c. and second microlens array portion 202b includes a number of second microlenses 202d2 that are arranged with their convex surfaces facing outward away from gap 202c. Each first microlens 202d1 and second microlens 202d2 has a central axis, and the central axes of the first microlenses 202d1 and second microlenses 202d2 are parallel to each other. In an embodiment, gap 202c has a 2 mm width between first microlens array portion 202a and second microlens array portion 202b. Other gap widths may be used.

In an embodiment, first microlens array 202 includes 24 first microlenses 202d1, and has dimensions of 2 mm×1 mm×1 mm, and has a radius of curvature of 2 mm. In an embodiment, first microlens array 202 includes 24 second microlenses 202d2, and has dimensions of 2 mm×1 mm×1 mm, and has a radius of curvature of 2 mm. In an embodiment, first microlens array 202 may be glass or plastic. Persons of ordinary skill in the art will understand that other numbers of microlenses, dimensions, materials and parameters for first microlens array 202 may be used.

First microlens array portion 202a and second microlens array portion 202b collect different angles of light from light source 126 and focus the light to polarization converter array 208. In some embodiments, second microlens array portion 202b has a curvature that outputs light into polarization convertor array at smaller divergent angles. In some embodiments, second microlens array portion 202b has a curvature of 2 mm. Other curvature values may be used.

Second microlens array 204 includes a number of third microlenses 204c on each of first surface 204a and second surface 204b. Third microlenses 204c are arranged with their convex surfaces facing outward, and each third microlens 204c has a central axis, with the central axes of the third microlenses 204c are parallel to each other. In an embodiment, second microlens array 204 includes 130 third microlenses 204c, and has dimensions of 0.5 mm×0.3 mm×1.5 mm, and has a radius of curvature of 0.56 mm. In an embodiment, second microlens array 204 may be glass or plastic. Persons of ordinary skill in the art will understand that other numbers of microlenses, dimensions, materials and parameters for second microlens array 204 may be used.

In some embodiments, light source 126 may include separate red, green and blue (RGB) illumination sources, and in other embodiments, there may be a white light source and filters used to represent different colors. In an embodiment, a color sequential LED device is used in light source 126. A color sequential device includes red, blue and green LEDs which are turned on in a sequential manner in timing with LCoS microdisplay 206 for making a full color image. In other examples, lasers rather than LEDs may be used. Individual display elements on LCoS microdisplay 206 are controlled by microdisplay circuitry 120 (FIG. 2A) to reflect or absorb the red, green and blue light to represent the color or shade of gray for grayscale indicated by display driver 114 (FIG. 2A) for the image data.

Referring now to FIG. 4C, another embodiment of image optical system 170 is described that may be used to fit within an optical system housing 170h having a constrained mechanical outline, such as may be required in NED Device 12. In particular, image optical system 170b includes light source 126, a first microlens array 202, a second microlens array 204 and a microdisplay 206. In some embodiments, image optical system 170b may include additional optical components, such as a diffractive grating 238, a waveplate 240, fold prism 212, fold prism with relay lens 214, mirror 216, relay lens 218, polarizer 220, and beamsplitter 222.

First microlens array 202 focuses projected light 224 from light source 126, diffractive grating 238 converts unpolarized light from first microlens array 202 to circular polarized light 242, and waveplate 240 converts circular polarized light 242 to linearly polarized light 244. In an embodiment, diffractive grating 238 has a grating period of 0.00294 mm, and waveplate 240 is a quarter waveplate. In some embodiments, waveplate 240 may include multiple waveplates that have alternating orthogonal axes, such as described in Jihwan Kim et al., “An Efficient And Monolithic Polarization Conversion System Based On A Polarization Grating,” Applied Optics, 51:20, pp. 4852-4857 (2012). Other grating periods and waveplate parameters may be used. Fold prism 212 folds linearly polarized light 244 an angle θ (e.g., θ=90°), and redirects the folded image light 228b to second microlens array 204.

Second microlens array 204 collects the folded light 228b from fold prism 212, and redirects the collected light to second surface 204b. In an embodiment, second microlens array 204 acts to further homogenize light, as third microlenses 204c can be made to much smaller sizes. Fold prism with relay lens 214 folds image light 230b from second microlens array 204 an angle α (e.g., α=90°), and magnifies the folded light to form magnified image light 232b. Mirror 216 reflects magnified image light 232b to direct reflected light 234b towards relay lens 218, which converges reflected light 234b (via polarizer 220 and beamsplitter 222) to microdisplay 206. Microdisplay 206 reflects imaged light 236, which is folded by beamsplitter 222 and output as image light 180.

Without wanting to be bound by any particular theory, it is believed that embodiments of image optical system 170 may provide a distinctive performance difference compared to single microlens array systems. In one example embodiment, the simulated min/max luminous intensity of the output of image optical system 170 at a 30×17 degree field of view is >0.8. This means dividing the image into 30 boxes (horizontally), 17 boxes (vertically), and getting the min/max of the image. This covers the extreme corners of the image and yet still maintains high uniformity.

Optical elements described herein may be made of glass or plastic material. Optical elements may be manufactured by molding, grinding and/or polishing. Optical elements may or may not be cemented to each other in embodiments. Optical elements described herein may be aspherical. In embodiments, single lens optical elements may be split into multiple lens elements. Better image quality may be achieved by replacing single lens optical elements with multiple lens optical elements so more lenses are used and hence more properties are available to be varied to achieve a particular image quality.

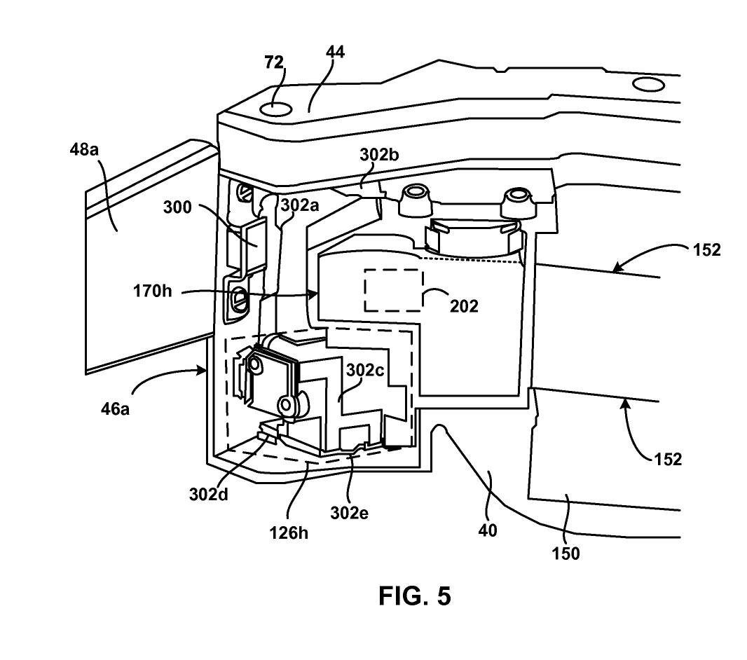

FIG. 5 illustrates an embodiment of a left side housing 46a for positioning projection light engine 24 with an external exit pupil 140 for optical coupling with a near-eye display in a NED Device using an eyeglass frame. Left side housing 46a is also referred to as the housing of a projection light engine. This view illustrates an example of how components of projection light engine 24 may be fitted within left side housing 46a. In alternate embodiments, components of projection light engine 24 may be disposed in a different arrangement and/or orientation to fit a different sized housing. A protective covering is removed to see the exemplary arrangement.

Left side housing 46a is connected and adjacent to frame top section 44 and left side arm 48a as well as a portion of frame 40 surrounding a left side display unit 150. In this example, a power supply feed 300 is located on the upper left interior of left side housing 46a, providing power from power supply 106 (FIG. 2A) for various components. Throughout left side housing 46a are various exemplary electrical connections 302a, 302b, 302c, 302d, and 302e for providing power as well as data representing instructions and values to the various components. An example of an electrical connection is a flex cable 302b which interfaces with control circuitry 52 which may be inside frame top section 44 as in FIG. 1, or elsewhere such as on or within a side arm 48.

Starting in the lower left is a housing structure 126h which encompasses components within the three dimensional space surrounded by the dashed line representing housing structure 126h. Housing structure 126h provides support and a protective covering for components of light source 126 (such as the one or more light sources of light source 126) and at least display illumination driver 124 (FIG. 2A). Display illumination driver 124 converts digital instructions to analog signals to drive one or more light sources like lasers or LEDs making up light source 126. Flex cable 302c also provides electrical connections.

In this embodiment, the illumination is directed onto first microlens array 202 (represented as a dashed line) within optical system housing 170h. Optical system housing 170h includes components of an image optical system 170, such as the embodiments described above. To avoid over-cluttering the drawing, additional components of image optical system 170 are not shown. In alternate embodiments, the electronics and optical elements shown in FIG. 5 may be disposed in an alternative orientation or arrangement with one or more different or combined supporting housings and/or structures.

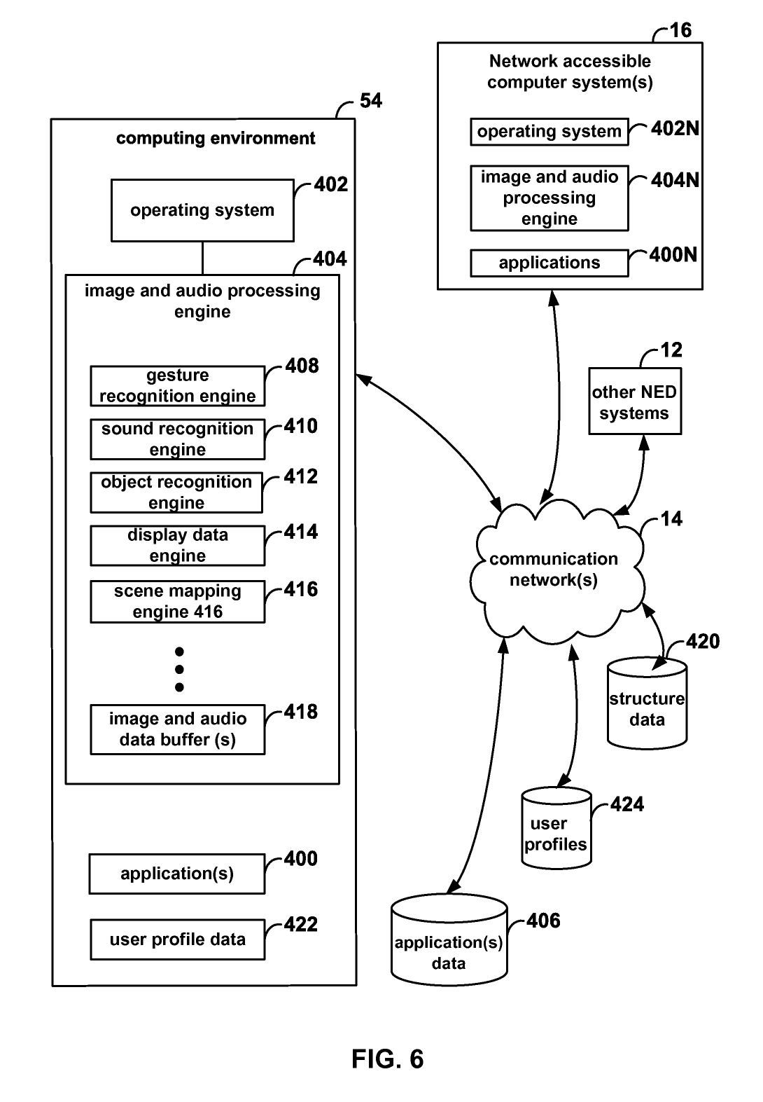

FIG. 6 is a block diagram of an embodiment of a system from a software perspective for displaying image data or light (such as a computer generated image) by a near-eye display device. FIG. 6 illustrates an embodiment of a computing environment 54 from a software perspective which may be implemented by a system like NED Device 12, network accessible computing system(s) 16 in communication with one or more NED Devices 12 or a combination thereof. Additionally, a NED Device 12 may communicate with other NED Devices for sharing data and processing resources.

As described herein, an executing application determines which image data is to be displayed, some examples of which are text, emails, virtual books or game related images. In an embodiment, an application 400 may be executing on one or more processors of NED Device 12 and communicating with an operating system 402 and an image and audio processing engine 404. In the illustrated embodiment, a network accessible computing system(s) 16 may also be executing a version 400N of the application as well as other NED Devices 12 with which it is in communication for enhancing the experience.

Application 400 includes a game in an embodiment. The game may be stored on a remote server and purchased from a console, computer, or smartphone in embodiments. The game may be executed in whole or in part on the server, console, computer, smartphone or on any combination thereof. Multiple users might interact with the game using standard controllers, computers, smartphones, or companion devices and use air gestures, touch, voice, or buttons to communicate with the game in embodiments.

Application(s) data 406 for one or more applications may also be stored in one or more network accessible locations. Some examples of application(s) data 406 may be one or more rule data stores for rules linking action responses to user input data, rules for determining which image data to display responsive to user input data, reference data for natural user input like for one or more gestures associated with the application which may be registered with a gesture recognition engine 408, execution criteria for the one or more gestures, voice user input commands which may be registered with a sound recognition engine 410, physics models for virtual objects associated with the application which may be registered with an optional physics engine (not shown) of the image and audio processing engine 404, and object properties like color, shape, facial features, clothing, etc. of the virtual objects and virtual imagery in a scene.

As shown in FIG. 6, the software components of a computing environment 54 comprise the image and audio processing engine 404 in communication with an operating system 402. The illustrated embodiment of an image and audio processing engine 404 includes an object recognition engine 412, gesture recognition engine 408, display data engine 414, a sound recognition engine 410, and a scene mapping engine 416. The individual engines and data stores provide a supporting platform of data and tasks which an application(s) 400 can leverage for implementing its one or more functions by sending requests identifying data for processing and receiving notification of data updates. The operating system 402 facilitates communication between the various engines and applications. The operating system 402 makes available to applications which objects have been identified by the object recognition engine 412, gestures the gesture recognition engine 408 has identified, which words or sounds the sound recognition engine 410 has identified, and the positions of objects, real and virtual from the scene mapping engine 416.

The computing environment 54 also stores data in image and audio data buffer(s) 418 which provide memory for image data and audio data which may be captured or received from various sources as well as memory space for image data to be displayed. The buffers may exist on both NED Device 12, e.g., as part of the overall memory 102 (FIG. 2A), and also may exist on the companion processing module 22 (FIG. 1).

In many applications, virtual data (or a virtual image) is to be displayed in relation to a real object in the real environment. Object recognition engine 412 of image and audio processing engine 404 detects and identifies real objects, their orientation, and their position in a display field of view based on captured image data and captured depth data from outward facing image capture devices 60 (FIG. 1) if available, or determined depth positions from stereopsis based on the image data of the real environment captured by capture devices 60.

Object recognition engine 412 distinguishes real objects from each other by marking object boundaries, for example using edge detection, and comparing the object boundaries with structure data 420. Besides identifying the type of object, an orientation of an identified object may be detected based on the comparison with stored structure data 420. Accessible over one or more communication networks 14, structure data 420 may store structural information such as structural patterns for comparison and image data as references for pattern recognition. Reference image data and structural patterns may also be available in user profile data 422 stored locally or accessible in Cloud based storage.

Scene mapping engine 416 tracks the three dimensional (3D) position, orientation, and movement of real and virtual objects in a 3D mapping of the display field of view. Image data is to be displayed in a user's field of view or in a 3D mapping of a volumetric space about the user based on communications with object recognition engine 412 and one or more executing application(s) 400 causing image data to be displayed.

Application(s) 400 identifies a target 3D space position in the 3D mapping of the display field of view for an object represented by image data and controlled by the application. For example, the helicopter shoot down application identifies changes in the position and object properties of the helicopters based on the user's actions to shoot down the virtual helicopters. Display data engine 414 performs translation, rotation, and scaling operations for display of the image data at the correct size and perspective. Display data engine 414 relates the target 3D space position in the display field of view to display coordinates of display unit 150.

For example, display data engine 414 may store image data for each separately addressable display location or area (e.g. a pixel, in a Z-buffer and a separate color buffer). Display driver 114 (FIG. 2A) translates the image data for each display area to digital control data instructions for microdisplay circuitry 120 or display illumination driver 124 or both for controlling display of image data by the image source.

The technology described herein may be embodied in other specific forms or environments without departing from the spirit or essential characteristics thereof. Likewise, the particular naming and division of modules, engines routines, applications, features, attributes, methodologies and other aspects are not mandatory, and the mechanisms that implement the technology or its features may have different names, divisions and/or formats.

The technology described herein may be embodied in a variety of operating environments. For example, NED Device 12 and/or network accessible computing system(s) 16 may be included in an Internet of Things embodiment. The Internet of Things embodiment may include a network of devices that may have the ability to capture information via sensors. Further, such devices may be able to track, interpret, and communicate collected information. These devices may act in accordance with user preferences and privacy settings to transmit information and work in cooperation with other devices. Information may be communicated directly among individual devices or via a network such as a local area network (LAN), wide area network (WAN), a “cloud” of interconnected LANs or WANs, or across the entire Internet. These devices may be integrated into computers, appliances, smartphones wearable devices, implantable devices, vehicles (e.g., automobiles, airplanes, and trains), toys, buildings, and other objects.

The technology described herein may also be embodied in a Big Data or Cloud operating environment as well. In a Cloud operating environment, information including data, images, engines, operating systems, and/or applications described herein may be accessed from a remote storage device via the Internet. In an embodiment, a modular rented private cloud may be used to access information remotely. In a Big Data operating embodiment, data sets have sizes beyond the ability of typically used software tools to capture, create, manage, and process the data within a tolerable elapsed time. In an embodiment, image data may be stored remotely in a Big Data operating embodiment.

FIGS. 7A-7B are flowcharts of embodiment of methods for operating a NED Device and/or system. The steps illustrated in FIGS. 7A-7B may be performed by optical elements, hardware components and software components, singly or in combination. For illustrative purposes, the method embodiments below are described in the context of the system and apparatus embodiments described above. However, the method embodiments are not limited to operating in the system embodiments described herein and may be implemented in other system embodiments. Furthermore, the method embodiments may be continuously performed while the NED Device system is in operation and an applicable application is executing.

Referring now to FIG. 7A, method 500 begins at step 502 by directing projected light from a light source to a first MLA. In an embodiment, projected light 224 is directed from light source 126 to first MLA 202, as illustrated in FIGS. 4A-4D.

Step 504 illustrates polarizing light from first MLA 202. In an embodiment, first MLA 202 focuses projected light 224 on polarization converter array 208, which forms polarized light 226, as illustrated in FIGS. 4A-4B. As in the embodiment illustrated in FIGS. 4A-4B, half-wave retarder 210 may be used in performing at least a portion of step 504. In another embodiment, diffractive grating 238 and waveplate 240 polarize light from first MLA 202, as illustrated in FIGS. 4C-4D.

Step 506 illustrates directing light from the first MLA to a second MLA. In an embodiment, polarized light 226 is directed to second MLA 204, as illustrated in FIGS. 4A-4B. As in the embodiment illustrated in FIGS. 4A-4B, fold prism 212 may be used in performing at least a portion of step 506. In another embodiment, polarized light 244 from first MLA 202 is directed to second MLA 204, as illustrated in FIGS. 4C-4D. As in the embodiment illustrated in FIGS. 4C-4D, fold prism 212 may be used in performing at least a portion of step 506.

Step 508 illustrates directing light from the second MLA to a microdisplay. In an embodiment, light 230a from second MLA 204 is directed to microdisplay 206. As in the embodiment illustrated in FIGS. 4A-4B, fold prism with relay lens 214, mirror 216, relay lens 218, polarizer 220, and beamsplitter 222 may be used in performing at least a portion of step 508. In another embodiment, light 230b from second MLA 204 is directed to microdisplay 206. As in the embodiment illustrated in FIGS. 4C-4D, fold prism with relay lens 214, mirror 216, relay lens 218, polarizer 220, and beamsplitter 222 may be used in performing at least a portion of step 508.

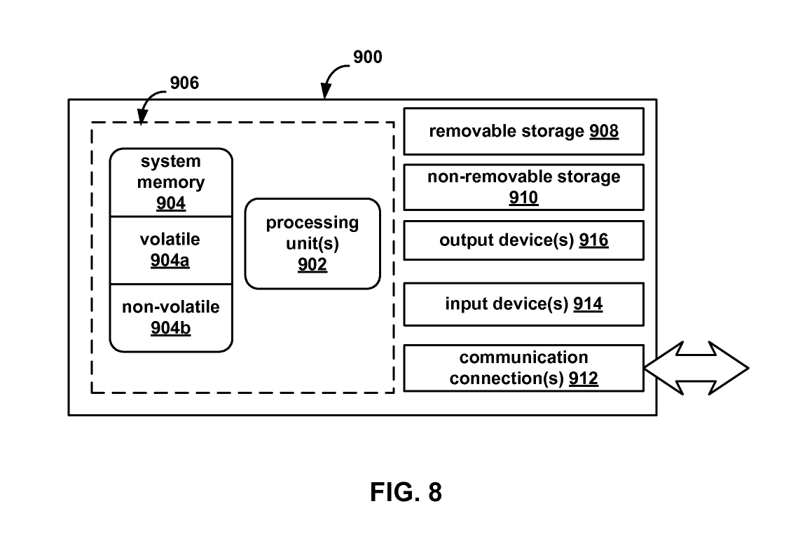

FIG. 8 is a block diagram of one embodiment of an exemplary computer system 900 that can be used to implement network accessible computing system(s) 16, companion processing module 22, or another embodiment of control circuitry 52 of head-mounted display 20. Computer system 900 may host at least some of the software components of computing environment 54. In an embodiment, computer system 900 may include a Cloud server, server, client, peer, desktop computer, laptop computer, hand-held processing device, tablet, smartphone and/or wearable computing/processing device.

In its most basic configuration, computer system 900 typically includes one or more processing units (or cores) 902 or one or more central processing units (CPU) and one or more graphics processing units (GPU). Computer system 900 also includes memory 904. Depending on the exact configuration and type of computer system, memory 904 may include volatile memory 904a (such as RAM), non-volatile memory 904b (such as ROM, flash memory, etc.) or some combination thereof. This most basic configuration is illustrated in FIG. 8 by dashed line 906.

Additionally, computer system 900 may also have additional features/functionality. For example, computer system 900 may also include additional storage (removable and/or non-removable) including, but not limited to, magnetic or optical disks or tape. Such additional storage is illustrated in FIG. 8 by removable storage 908 and non-removable storage 910.

Alternatively, or in addition to processing unit(s) 902, the functionally described herein can be performed or executed, at least in part, by one or more other hardware logic components. For example, and without limitation, illustrative types of hardware logic components that can be used include Field-programmable Gate Arrays (FPGAs), Program Application-specific Integrated Circuits (ASICs), Program Application-specific Standard Products (ASSPs), System-on-a-chip systems (SOCs), Complex Programmable Logic Devices (CPLDs) and other like type of hardware logic components.

Computer system 900 also may contain communication module(s) 912 including one or more network interfaces and transceivers that allow the device to communicate with other computer systems. Computer system 900 also may have input device(s) 914 such as keyboard, mouse, pen, microphone, touch input device, gesture recognition device, facial recognition device, tracking device or similar input device. Output device(s) 916 such as a display, speaker, printer, or similar output device also may be included.

A user interface (UI) software component to interface with a user may be stored in and executed by computer system 900. In an embodiment, computer system 900 stores and executes a natural language user interface (NUI) and/or 3D UI. Examples of NUIs include using speech recognition, touch and stylus recognition, gesture recognition both on screen and adjacent to the screen, air gestures, head and eye tracking, voice and speech, vision, touch, hover, gestures, and machine intelligence. Specific categories of NUI technologies include for example, touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which may provide a more natural interface, as well as technologies for sensing brain activity using electric field sensing electrodes (EEG and related methods).

A UI (including a NUI) software component may be at least partially executed and/or stored on a local computer, tablet, smartphone, NED Device system. In an alternate embodiment, a UI may be at least partially executed and/or stored on server and sent to a client. The UI may be generated as part of a service, and it may be integrated with other services, such as social networking services.

The example computer systems illustrated in the figures include examples of computer readable storage devices. A computer readable storage device is also a processor readable storage device. Such devices may include volatile and nonvolatile, removable and non-removable memory devices implemented in any method or technology for storage of information such as computer readable instructions, data structures, program modules or other data. Some examples of processor or computer readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the information and which can be accessed by a computer.

### Aspects of Certain Embodiments

One or more embodiments include an optical system for converting a source of projected light to uniform image light for a liquid crystal on silicon microdisplay in a confined space. In an embodiment, the optical system includes a first microlens array, a second microlens array, and a polarizer device disposed between the first microlens array and the second microlens array.

In a system embodiment, the first microlens array includes a first microlens array portion, a second microlens array portion, and a gap disposed between the first microlens array portion and the second microlens array portion.

In a system embodiment, the first microlens array portion includes a plurality of first microlenses.

In another system embodiment, the second microlens array portion includes a plurality of second microlenses.

In a system embodiment, the gap has a width of 2 mm.

In a system embodiment, the second microlens array includes a first surface and a second surface. The first surface and the second surface each includes a plurality of third microlenses.

In a system embodiment, the polarizer device comprises a polarization converter array.

In a system embodiment, the polarization converter array includes a MacNeille beam splitter.

In a system embodiment, the polarizer device includes a diffractive grating and a waveplate disposed between the first microlens array and the second microlens array.

One or more embodiments include a method for converting a source of projected light to uniform image light for a liquid crystal on silicon microdisplay in a confined space. In an embodiment, the method includes directing the projected light to a first microlens array, polarizing light from the first microlens array, directing the polarized light a second microlens array to generate the uniform light, and directing the uniform light from the second microlens array to the liquid crystal on silicon microdisplay.

In a method embodiment, polarizing includes focusing light from the first microlens array on a polarization converter array.

In a method embodiment, the polarization converter array includes a MacNeille beam splitter.

In another method embodiment, polarizing includes directing light from the first microlens array to a diffractive grating and a waveplate.

In a method embodiment, the diffractive grating comprises a grating period.

In a method embodiment, the diffractive waveplate comprises a quarter waveplate.

One or more apparatus embodiments includes a computing system and a head-mounted display having a near-eye display. An apparatus embodiment includes a computer system that provides an electronic signal representing image data. A head-mounted display provides image data in response to the electronic signal. The head-mounted display includes a near-eye display device having a projection light engine. In an embodiment, the projection light engine includes a microdisplay to provide the image data in response to the electronic signal, a light source to provide projected light, a first microlens array to receive the projected light from the light source, a polarizer device to generate polarized light from the first microlens array, and a second microlens array to receive the polarized light from the polarizer and to provide uniform light to the microdisplay.

In an apparatus embodiment, the first microlens array includes a first microlens array portion, a second microlens array portion, and a gap disposed between the first microlens array portion and the second microlens array portion.

In an embodiment, the second microlens array includes a first surface and a second surface. The first surface and the second surface each include a plurality of third microlenses.

In an apparatus embodiment, the polarizer device includes a polarization converter array.

In an apparatus embodiment, the polarizer device includes a diffractive grating and a waveplate disposed between the first microlens array and the second microlens array.

One or more embodiments include an optical system means (170) for converting a source of projected light to uniform image light for a liquid crystal on silicon microdisplay means (206) in a confined space. In an embodiment, the optical system means (170) includes a first microlens array means (202), a second microlens array means (204), and a polarizer device means (208) disposed between the first microlens array means (202) and the second microlens array means (204).

Embodiments described in the previous paragraphs may also be combined with one or more of the specifically disclosed alternatives.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

1. An optical system for converting a source of projected light to uniform image light for a liquid crystal on silicon microdisplay in a confined space, the optical system comprising:
a first microlens array;
a second microlens array; and
a polarizer device disposed between the first microlens array and the second microlens array.

2. The optical system of claim 1, wherein the first microlens array comprises:
a first microlens array portion;
a second microlens array portion; and
a gap disposed between the first microlens array portion and the second microlens array portion.

3. The optical system of claim 2, wherein the first microlens array portion includes a plurality of first microlenses.

4. The optical system of claim 2, wherein the second microlens array portion includes a plurality of second microlenses.

5. The optical system of claim 2, wherein the gap comprises a width of 2 mm.

6. The optical system of claim 1, wherein the second microlens array comprises:
a first surface; and
a second surface,
wherein the first surface and the second surface each comprise a plurality of third microlenses.

7. The optical system of claim 1, wherein the polarizer device comprises a polarization converter array.

8. The optical system of claim 7, wherein the polarization converter array comprises a MacNeille beam splitter.

9. The optical system of claim 1, wherein the polarizer device comprises a diffractive grating and a waveplate disposed between the first microlens array and the second microlens array.

10. A method for converting a source of projected light to uniform image light for a liquid crystal on silicon microdisplay in a confined space, the method comprising:
directing the projected light to a first microlens array;
polarizing light from the first microlens array;
directing the polarized light a second microlens array to generate the uniform light; and
directing the uniform light from the second microlens array to the liquid crystal on silicon microdisplay.

11. The method of claim 10, wherein polarizing comprises focusing light from the first microlens array on a polarization converter array.

12. The method of claim 11, wherein the polarization converter array comprises a MacNeille beam splitter.

13. The method of claim 10, wherein polarizing comprises directing light from the first microlens array to a diffractive grating and a waveplate.

14. The method of claim 13, wherein the diffractive grating comprises a grating period.

15. The method of claim 13, wherein the waveplate comprises a quarter waveplate.

16. An apparatus comprising:
a computer system that provides an electronic signal representing image data; and
a head-mounted display that provides image data in response to the electronic signal, wherein the head-mounted display includes:
a near-eye display device including:
a projection light engine including:
a microdisplay to provide the image data in response to the electronic signal;
a light source to provide projected light;
a first microlens array to receive the projected light from the light source;
a polarizer device to generate polarized light from the first microlens array; and
a second microlens array to receive the polarized light from the polarizer and to provide uniform light to the microdisplay.

17. The apparatus of claim 16, wherein the first microlens array comprises:
a first microlens array portion;
a second microlens array portion; and
a gap disposed between the first microlens array portion and the second microlens array portion.

18. The apparatus of claim 16, wherein the second microlens array comprises:
a first surface; and
a second surface,
wherein the first surface and the second surface each comprise a plurality of third microlenses.

19. The apparatus of claim 16, wherein the polarizer device comprises a polarization converter array.

20. The apparatus of claim 16, wherein the polarizer device comprises a diffractive grating and a waveplate disposed between the first microlens array and the second microlens array.
